(19) United States
(12) Patent Application Publication
(10) Pub. No.: US 2008/0155110 A1
(43) Pub. Date: Jun. 26, 2008

(54) METHODS AND SYSTEMS FOR DETERMINING SCHEME HANDLING PROCEDURES FOR PROCESSING URIs BASED ON URI SCHEME MODIFIERS

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/615,438

(22) Filed: Dec. 22, 2006

(51) Int. Cl. G06F 15/16

(52) U.S. Cl. 709/230

(57) ABSTRACT

Methods and systems are described for determining scheme handling procedures for processing URIs based on URI scheme modifiers. A URI is received having a URI scheme name, a URI scheme modifier, and a scheme hierarchical part. The URI scheme name identifies a first scheme handling procedure for processing the URI. The URI scheme modifier is detected in the received URI. Based on the detected URI scheme modifier, a second scheme handling procedure is determined for processing the URI. The determined second scheme handling procedure is used to process the URI for performing an operation based on the URI.

### BACKGROUND

A uniform resource identifier (URI) is a compact string of characters used to identify or name a resource. The main purpose of this identification is to enable interaction with representations of the resource over a network, typically the World Wide Web, using specific protocols. URIs are defined in schemes defining a specific syntax and can identify associated protocols. A URI can be classified as a locator, a name, or both.

A URI scheme is the top level of the URI naming structure. Conventional URIs are formed with a “scheme name” portion followed by a colon character, and the remainder of the URI, which is called the “hierarchical part” in the current Internet Standard STD 66 and the Internet engineering task force (IETF) RFC 3986 (formerly called the “scheme-specific part” in the outdated RFCs 1738 and 2396). The syntax and semantics of the hierarchical part are left largely to the specifications governing individual schemes, subject to certain constraints. URIs and their subsets, uniform resource locaters (URLs) and uniform resource names (URNs), have been invaluable in the growth of the web.

A URN is a URI that can be used to identify a resource without implying its location or how to reference it. For example, the URN “isbn:0-395-36341-1” is a URI that, like an international standard book number (ISBN), allows one to identify a book, but does not suggest where and how to obtain an actual copy of it.

A URL is a URI that, in addition to identifying a resource, provides a means of acting upon or obtaining a representation of the resource by describing its primary access mechanism or network “location”.

The current view among the working group that oversees URIs is that the terms URL and URN are context-dependent aspects of URIs, and rarely need to be distinguished.

The basic syntax for a URI is:
<scheme>:<hierarchical-part>

This basic syntax is quite flexible, particularly the hierarchical part, which allows for information related to naming authority, address information, relative path, parameter, and query information. For example, a syntax that further details the hierarchical part can be:
<scheme>://<authority><path>?<query>

The scheme portion, on the other hand is static, simply identifying a class of identifiers. In the case of URLs, the scheme also identifies an access means, such as a protocol. For example, hypertext transfer protocol (HTTP) may be identified in the scheme using the “http:” syntax.

Schemes, in general, and schemes for URLs in particular, cannot be supplemented with other useful information for determining scheme handling procedures for processing URIs, such as scheme modifiers, which can include scheme parameters and scheme extensions.

Accordingly, there exists a need for methods, systems, and computer program products for determining scheme handling procedures for processing URIs based on URI scheme modifiers.

### SUMMARY

Methods and systems are described for determining scheme handling procedures for processing URIs based on URI scheme modifiers. A URI is received having a URI scheme name, a URI scheme modifier, and a scheme hierarchical part. The URI scheme name identifies a first scheme handling procedure for processing the URI. The URI scheme modifier is detected in the received URI. Based on the detected URI scheme modifier, a second scheme handling procedure is determined for processing the URI. The determined second scheme handling procedure is used to process the URI for performing an operation based on the URI.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for determining scheme handling procedures for processing URIs based on URI scheme modifiers according to an embodiment of the subject matter described herein;

FIG. 2 is a block diagram illustrating a system for determining scheme handling procedures for processing URIs based on URI scheme modifiers according to another embodiment of the subject matter described herein; and

FIG. 3 is a block diagram illustrating a system for determining scheme handling procedures for processing URIs based on URI scheme modifiers according to another embodiment of the subject matter described herein.

### DETAILED DESCRIPTION

Every URI can generally be defined as consisting of four parts, as follows:
<scheme name>:<hierarchical part>[?<query>][#<fragment>]

The scheme name consists of a letter followed by any combination of letters, digits, and the plus (“+”), period (“.”), or hyphen (“−”) characters; and is terminated by a colon (“:”).

The hierarchical part of the URI is intended to hold identification information hierarchical in nature. Usually this part begins with a double forward slash (“//”), followed by an authority part and an optional path. The authority part holds an optional user information part terminated with “@” (e.g. username:password@), a hostname (i.e. domain name or IP address), and an optional port number preceded by a colon “:”. The path part is a sequence of segments (conceptually similar to directories, though not necessarily representing them) separated by a forward slash (“/”). Each segment can contain parameters separated from it using a semicolon (“;”), though this is rarely used in practice.

The query is an optional part separated with a question mark, which contains additional identification information, which is not hierarchical in nature. Its syntax is not generically defined, but is commonly organized as a sequence of <key>=<value>pairs separated by an ampersand, e.g. key1=value1&key2=value2&key3=value3.

The fragment is an optional part separated from the front parts by a hash (“#”). It holds additional identifying information, which allows indirect identification of a secondary resource, e.g. a section heading in an article identified by the remainder of the URI.

An example HTTP URI is shown below:

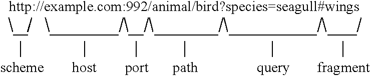

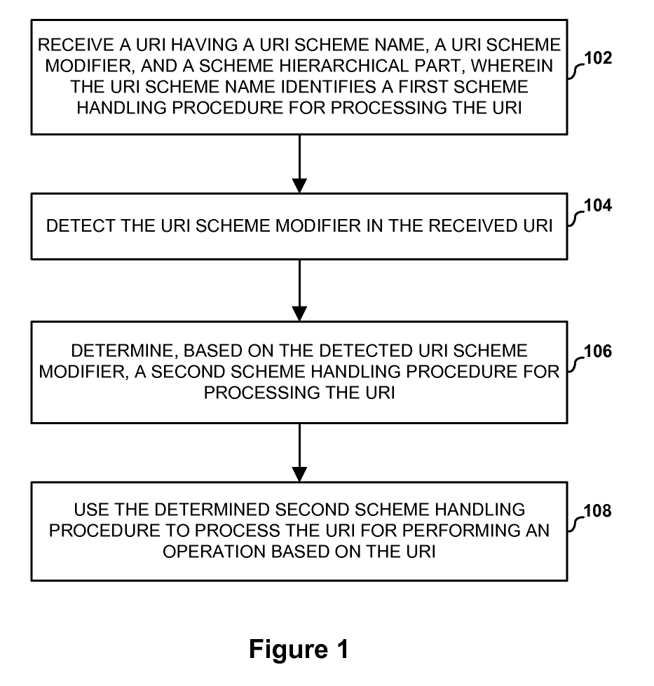

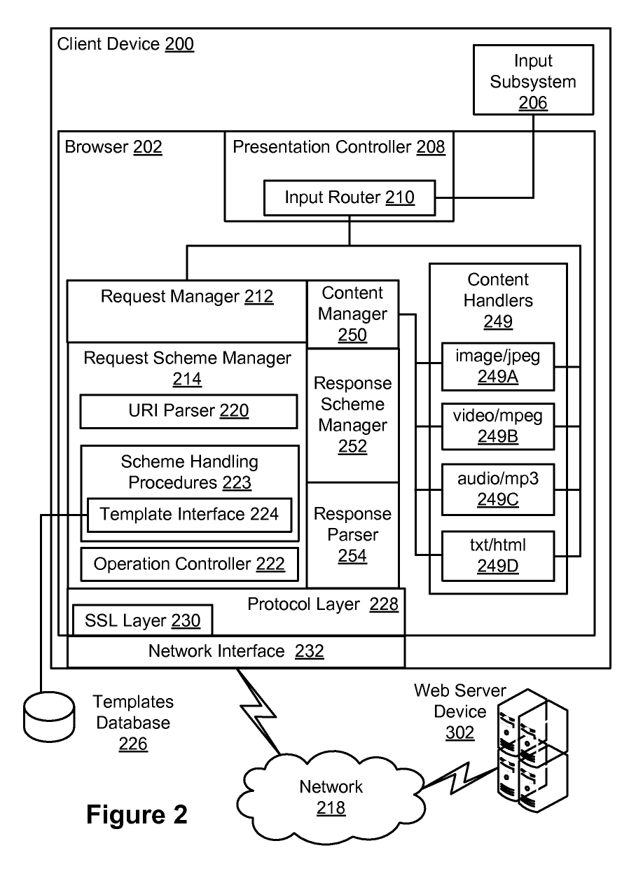

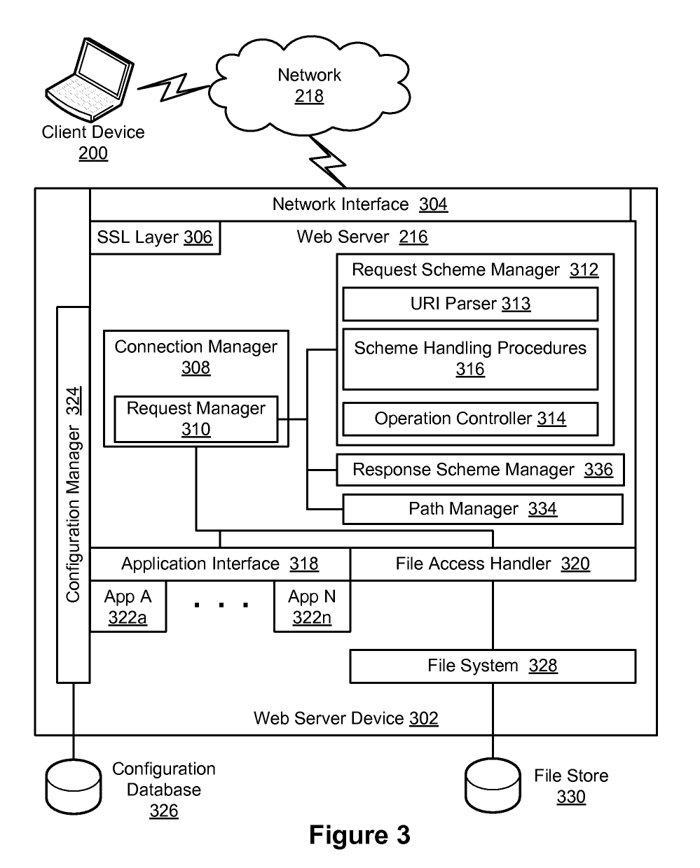

FIG. 1 is a flow diagram illustrating a method for determining scheme handling procedures for processing URIs based on URI scheme modifiers according to another exemplary embodiment of the subject matter described herein. FIGS. 2 and 3 are block diagrams illustrating systems for determining scheme handling procedures for processing URIs based on URI scheme modifiers according to embodiments of the subject matter described herein. In particular, FIG. 2 illustrates a client-based system for determining scheme handling procedures for processing URIs based on URI scheme modifiers, while FIG. 3 illustrates a server-based system for determining scheme handling procedures for processing URIs based on URI scheme modifiers. The method illustrated in FIG. 1 can be carried out by, for example, each of the exemplary systems illustrated in FIGS. 2 and 3.

Illustrated in FIG. 2 is a browser 202 operating within an execution environment (not shown) of a client device 200. Client device 200 and a web server device 302 can communicate via a network 218, which may be, for example, a direct link, a local area network (LAN), an intranet, a wide area network (WAN) such as the Internet, and the like, or any combination thereof. Browsers, as is well-known in this art, receive and process URLs provided by users entered in a location bar, for example, and URLs included in links in web content. Thus, a browser 202 is one example of an URI processing application. Any application or service that processes URIs may be modified or configured to support the subject matter described herein.

Example 1 below depicts an exemplary URI format allowing scheme modifiers to be included according to an aspect of the subject matter described herein.

### EXAMPLE 1

<scheme name>[<scheme modifier part>]:<hierarchical part>[?<query>][#<fragment>]

Example 2 below depicts an exemplary URL complying with the format of Example 1 that browser 202 is enabled to process.

### EXAMPLE 2

http;command=GET,transport=ssl,content-type=+image/*://www.example.com/myPage

The URL shown in Example 2 uses the HTTP scheme as identified by the scheme name. The path or hierarchical part includes a host identifier, “www.example.com”, and a relative path, “myPage”, that identifies a particular resource or service. A scheme modifier part, “command=GET,transport=ssl,content-type=+image/*”, includes three keyword-value pairs, each of which identifies a scheme modifier. The scheme modifier part enables a provider of a URI to specify, among other things, a second scheme handling procedure for processing of the URI based on a detected scheme modifier in addition to a first scheme handling procedure identified by the scheme name part, by, for example, an application or service, such as browser 202, as will be described.

With reference to FIG. 1, in block 102 a URI is received having a URI scheme name, a URI scheme modifier, and a scheme hierarchical part. The URI scheme name identifies a first scheme handling procedure for processing the URI. Accordingly, a system for determining scheme handling procedures for processing URIs based on URI scheme modifiers includes means for receiving a URI having a URI scheme name, a URI scheme modifier, and a scheme hierarchical part, where the URI scheme name identifies a first scheme handling procedure for processing the URI. For example, as illustrated in FIG. 2, a request manager component 212 is configured for receiving a URI having a URI scheme name, a URI scheme modifier, and a scheme hierarchical part. The request manager component 212 using the URI scheme name identifies a first scheme handling procedure for processing the URI, such as an identified scheme handling procedure of scheme handling procedures 223 of a scheme manager component 214

In one embodiment, the request manager component 212 is configured for receiving a URI at a client device 200 via an input subsystem 206 of the client device 200. For example, in FIG. 2, a URI can be received by the request manager component 212 via input subsystem 206 of client device 200 as a result of a user typing a URL into a location bar of the browser 202 or a result of the user selecting a bookmark maintained by the browser 202. Alternatively, a URL and a specified HTTP command type can be received via the input subsystem component 206 as a result of, for example, receiving a selection of a link displayed on a web page by presentation controller 208 as directed by one or more content handlers 249 of the browser 202, such as an image content handler 249A, a video content handler 249B, an audio content handler 249C, and/or an HTML content handler 249D. The input subsystem component 206 can pass a representation of the input received to an input router 210 included in the presentation controller 208. If the input is received via the location bar, the input router 210 can pass the input to a content manager 250 for processing. If the input is received via a web page, the input router 210 can pass the input to the content handler 249 associated with a portion of the web page corresponding to the received input, such as the HTML content handler 249D. The HTML content handler 249D, for example, can pass the input received, including at least a portion of a URI to the content manager 250. In any case, the URI is forwarded to the request manager component 212 for processing via the content manager 250.

The request manager component 212 can process the received URI using the scheme name of each URI to identify a first scheme handling procedure for processing the URI. For example, the URL of Example 2 can be passed to a request scheme manager component 214 including the first scheme handling procedure of scheme handling procedures 223 by the request manager component 212 based on a detected association between the scheme name, HTTP, and the request scheme manager component 214, which can be configured to manage HTTP requests. That is, the request scheme manager component 214 can be configured to build requests compatible with the HTTP protocol for the purpose of sending a message to an HTTP compatible server, such as the web server device 302 over the network 218.

With reference to the web server device 302 illustrated in FIG. 3, in another embodiment, a request manager component 310 is configured for receiving a URI having a URI scheme name, a URI scheme modifier, and a scheme hierarchical part, wherein the URI scheme name identifies a first scheme handling procedure for processing the URI. In one aspect, the request manager component 310 can be configured for receiving a URI in a message. For example, the request manager component 310 can be configured for receiving a URI in an HTTP request. Further, request manager 310 can use the scheme name of a received URI for identifying a request scheme manager component 312 capable of processing the URI using a first scheme handling procedure from among scheme handling procedures 316 included in a request scheme manager component 312.

Illustrated in FIG. 3 are the client device 200 and the web server device 302 that includes a web server 303 operating within an execution environment (not shown) of the web server device 302. The web server 303 is enabled to receive messages and send associated responses either on its own or in conjunction with one or more web applications 322a-322n, collectively referred to as web applications 322. In FIG. 3, an HTTP request message is received by the web server device 303 via the network 218 initially at a network interface component 304, which can process and remove various network protocol layer headers and trailers before the message is passed to the request manager component 310 associated with a connection manager 308 of web server 303. In some cases, the message may be passed through an additional session layer protocol for additional services. For example, the web server device 302 can include a secure sockets layer (SSL) component 306 for supporting requests and responses using the secure HTTPS URL scheme. In one aspect, an HTTP request received by the web server 303 can be processed by an application protocol layer represented by the request scheme manager component 312, described below.

The received message can be, for example, an HTTP request that is associated with a transmission control protocol (TCP) connection created at the request of the client device 200 and accepted by the network interface component 304 of the web server device 302 as directed by the web server 303. The connection associated with the HTTP request can remain open to provide for full-duplex communication between the client device 200 and the web server 303. The connection manager 308 can be responsible for managing the input and output streams of the full-duplex connection to and from the web server 303. The request manager component 310 receives a URI as part of the input stream. Using the scheme name as an identifier, the request manager 310 identifies a first scheme handling procedure for processing the URI. For example, if the scheme is HTTP as in the previous example, the request manager 310 identifies the request scheme manager component 312 including the first scheme handling procedure for processing the URI.

The connection manager 308 has responsibilities that can include, for example, determining a component of the web server 303 or web application 322a-n to which to direct a received request in conjunction with the identified request scheme manager component 312 including the first scheme handling procedure. The connection manager 308 can use a path manager 334 that when provided by the request scheme manager 312 with at least a portion of the path part of the URI associated with a request can determine a web application from the web applications 322 available or a web server 303 component that can be responsible for handling requests associated with the at least a portion of the path part of the URI. The path manager 334 can use a table that associates at least a portion of a set of URI path parts with for example, a web application entry point, such as a java servlet through an application interface 318; or a web server 303 component, such as a file access handler 320. The table information used by the path manager 334 can be accessed via a configuration manager 324. The configuration manager 324 can be enabled to receive, store in a configuration database 326, and retrieve configuration data for components of web server 303 as well as web applications 322 and any web server 303 extensions or add-ons.

A variety of application interfaces are currently in use in addition to Java's J2EE platform interface between a J2EE container and a web server 303 including the well-known CGI interface. Most web servers supporting HTTP provide a file handler by default or as an add-on. A file handler is enabled to respond to HTTP GET, PUT, POST, and DELETE commands to operate on files and other static resources available to the web server 303 identified by a URI included in the request. The file access handler 320 in the web server device 302 can use a file system 328 provided by and in conjunction with an operating system (not shown) of the web server device 302 to perform operations as directed on files in a file store 330, such as a hard-drive and other accessible resources provided through other available means on the web server device 302. Other services can be built into web servers in addition to file handlers.

In the current example, a URI having scheme modifiers is received over a network or from another component of a device in connection with the receipt of a message. The URI may or may not include all of the scheme modifiers provided to the URI by the sender of the message. For example, scheme modifiers affecting only the processing of a URI by the sender of a message can be removed from the URI before the URI is transmitted in connection with the message. It in another aspect, the entire URI or a portion of a URI, such as a relative URI, including the scheme modifiers can be received. In any case, such scheme modifiers received in URIs received in connection with the message will be referred to as receiver scheme modifiers. A receiver scheme modifier, in this embodiment, allows a sender of a message to specify a scheme modifier that is included in the URI which is sent in connection with a message to the receiver.

Returning to FIG. 1, in block 104 the URI scheme modifier is detected in the received URI. Accordingly, a system for determining scheme handling procedures for processing URIs based on URI scheme modifiers includes means for detecting the URI scheme modifier in the received URI. For example, as illustrated in FIG. 2, a URI parser component 220 is configured for detecting the URI scheme modifier in the received URI.

In one aspect, the URI parser component 220 is configured for parsing the URI for detecting a scheme modifier in the received URI. For example, returning to FIG. 2, the request scheme manager component 214 includes procedures for performing various tasks in building a request, such as an HTTP request. Request scheme manager component 214 includes a URI parser component 220 configured to parse a request to detect scheme modifiers. URI parser component 220 is preferably also capable of detecting and parsing the standard URI request format as well as detecting and parsing the scheme modifiers. Parsing an HTTP request in a standard format is typically performed to determine the protocol associated with the scheme and to identify a host name or address to use in sending the request. The remainder of the URI is not required in browsers 202 in order to build and send a request. Since scheme modifiers affect the handling of a URI, as is discussed below, additional parsing is performed in order to detect any scheme modifiers.

In the current example, a URL is parsed by the URI parser component 220 of the request scheme manager component 214. Request scheme manager component 214 can invoke the URI parser component 220 procedure to parse and detect HTTP URL elements and any scheme modifiers in the URL. Referring to the URL in Example 2 for illustration, the URI parser component 220 can parse the URL and detect the two scheme modifiers identified by the keyword-values, “command=G ET,transport=ssl,content-type=+image/*”.

In several alternative aspects, the URI scheme modifier can be specified in the URI using one of a positional format, a keyword-value format, and a command format. Several exemplary URI format extensions allowing scheme modifiers to be included in a URI, where the scheme modifiers may be located in various locations, are described below. For example, two possible locations for the scheme modifiers are illustrated in Example Formats 1 and 2 below. In Example Format 1, the scheme modifier is located between the scheme name and the “:”. In Example Format 2, the scheme modifiers located preceding the scheme identifier.

### EXAMPLE FORMAT 1

<scheme><scheme-modifier>://<authority><path>?<query><#fragment>

### EXAMPLE FORMAT 2

<scheme-modifier><scheme>://<authority><path>?<query>

Within a scheme-modifier portion of a URI, the scheme modifier may be specified in a variety of formats. Three exemplary classes of formats include: a positional format, where each scheme modifier is assigned a specific location in the scheme modifier portion of the URI and if no a modifier is specified for a particular position, the position can be marked as empty; a keyword-value format, as discussed above; and a command format, in which format values may not be assigned to a scheme modifier and each scheme modifier is a value whose purpose is predefined. Of course a mix of the three formats may also be used.

An exemplary scheme modifier portion based on a positional format is “http.text/xml.ssl:// . . . ”, where dots (“.”) separate positions. Other separators, such as “;”, can also be used. The first position in the example is reserved for content type, the second position is reserved for some other parameter/modifier, the third position is reserved for security indicating that what is now denoted as https is to be used, and modifiers from the fourth position on assume their default values, thus, they are not specified. In the example, the scheme identifier is HTTP, indicating HTTP is to be used as the access protocol. The term “text/xml” indicates the type of content acceptable in a response and can specify multiple MIME types. The value in this position can be used to modify an HTTP header by indicating acceptable MIME types. The “ssl” parameter is positioned to indicate a transport protocol. TCP is the default transport, but in this case an SSL session is created, the HTTP command transmitted over the SSL session, and a response received over the SSL session. Where HTTPS allows for HTTP over SSL only, the transport illustrated scheme modifier can allow HTTP to be used with other security protocols and other non-secure transport protocols other than TCP. In current browsers, neither URIs entered via the location bar nor received via links in a web page are capable of specifying the accepted content type of the response as was just illustrated. Browsers currently send HTTP requests based on URIs received via a location bar and links not associated with forms using an HTTP GET command and send HTTP requests associated with HTML forms using an HTTP POST command. The use of a command scheme modifier as illustrated allows a user providing a URI via a location bar and a developer of a web page to instruct a browser to alter its normal processing in these contexts to generate requests in conformance with a scheme modifier included in a URI. Thus a web developer may cause a browser to send form data to a web server using a GET command rather than a POST command, where the form data is passed as URI parameters rather than as request content. In effect, the detection of a scheme modifier identifies a second scheme handling procedure or a second path through a scheme handler's instructions not available in current browsers in order to process the URI based on a detected scheme modifier.

An exemplary scheme modifier portion based on a command format is “http:r-reset-cookies,+text/html,www.example.us:// . . . ”. In the example, r-reset cookies is a receiver scheme modifier request that the receiver reset all cookies in the next response. +text/html is recognized as a MIME type and indicates that text/html is to be included in the HTTP Accept header and is a sender scheme modifier. Another example sender scheme modifier is illustrated in the URL, ftp:dest=“.\mydocs\mypdfs”:// . . . ”. In the example, the value of the scheme modifier, “dest”, informs the sender where the received document should be placed. This is not possible with URIs currently. Of particular interest is that the “dest” scheme modifier changes the behavior of the receiving of the response by the sender of the URI. In yet another example, the URI, “http;copy-dest=“http;method-PUT:myServer/archive”:// . . . ”, contains a receiver modifier, “copy-dest”. The “copy-dest” modifier instructs the receiver of a request including the URI to place a copy of the content of a response to the request in a specified location identified by the path portion, “/archive”, on an identified server, “myServer”, using an HTTP PUT command. That is, the receiver of the request is to respond as usual to the request including the URI to the sender of the request and put a copy of the content of the response in the specified location using the specified protocol and protocol command. Using a scheme modifier allows a scheme processing portion of the receiver such as a web server to perform the requested processing. Currently, to perform this function a receiving application of a web server would have to be modified to receive query parameters indicating that the application should place a copy of the content on the archive server. The scheme modifier approach provides this functionality for all web applications without modifying any of the web applications. The example illustrates nested scheme modifiers and clearly illustrates a capability not possible using current URI formats.

An exemplary scheme modifier portion based on mixed positional and keyword-value formats is “http;text/xml.ssl;method=GET.accept=img/*:// . . . ”, where the first set of parameters are positional, and are separated from the keyword-value parameters by a “;”. It is not currently possible in a URI to specify a protocol command or method to be used in a scheme. While the examples provided use HTTP, one skilled in the art can easily see that scheme modifiers provide similar function for other schemes, such as ftp, xmpp, gopher, mailto, and URNs such as isbn.

As illustrated in the web server device 302 of FIG. 3, a URI parser component 313 is configured for detecting the URI scheme modifier in the received URI. The URI parser component 313 can be configured to parse the URI for detecting the scheme modifier. The URI parser component 313 is associated with a request scheme manager component 312 and receives the URI from the request manager 310. For example, the URI may be an HTTP URL with a receiver scheme modifier received in connection with an HTTP request. Example 3 below depicts an HTTP URL with a receiver scheme modifier identified by the prefix “r-”, according to one possible format.

### EXAMPLE 3

http;r-cookies=new://www.example.com/myPage

The “r-cookies=new” receiver scheme modifier can be ignored by the sender and simply passed through to the receiver by leaving it in the URI included in the sent message. In this example, the “new” value indicates the sender is requesting that the receiver reset all cookie values. For example, if a session ID is exchanged in a cookie, the effect is that the sender is requesting a replacement for the current session ID (not a new session). Other receiver scheme modifier examples have been previously discussed.

Returning to FIG. 1, in block 106 a second scheme handling procedure for processing the URI is determined based on the detected URI scheme modifier. Accordingly, a system for determining scheme handling procedures for processing URIs based on URI scheme modifiers includes means for determining, based on the detected URI scheme modifier, a second scheme handling procedure for processing the URI. For example, as illustrated in FIG. 2, a scheme manager component 214 is configured for determining, based on the detected URI scheme modifier, a second scheme handling procedure for processing the URI from among the scheme handling procedures 223.

The second scheme handling procedure for processing the URI based on the detected URI scheme modifier is different from the first scheme handling procedure. The first scheme handling procedure is associated with the scheme only. For example, the HTTP scheme requires a URI with the scheme name HTTP to identify a first scheme handling procedure capable of processing HTTP URIs, such as a routine for sending a HTTP request to a location based on a URI. For example, in current browsers the scheme name of HTTP identifies a first scheme handling procedure for sending HTTP requests. A scheme name of FTP identifies a first scheme handling procedure for sending HTTP requests. URIs currently provided to these routines are processed in a manner determined by the browser as described earlier providing little control to a web developer or a user of the browser in determining the processing performed based on a provided URI. Scheme modifiers allow users of applications that use URIs to alter the processing of a request and/or a response by including a scheme modifier in a URI. The scheme modifier causes the processing of the URI to be enhanced or modified. This additional processing is performed by a second scheme handler associated with a scheme modifier. The term “procedure” as used in this document includes functions, subroutines, methods associated with objects, and code blocks including flow control blocks such as conditionals and loops. That is, a second scheme handling procedure is any portion of the processing of a URI that is performed based on the presence of a scheme modifier in a URI. Thus, each of the examples of scheme modifiers in this document causes a request or response based on a URI to modify its processing. A second procedure determined based on a scheme modifier performs the modified and/or enhanced processing.

The detection and parsing of standard URI elements for the purpose of detecting URI scheme modifiers are described above with reference to the respective URI parser component 220. Based on a scheme modifier detected and identified by the URI parser component 220, the scheme manager component 214 determines a second scheme handling procedure associated with the detected scheme modifier for processing the URI. For example, the request scheme manager component 214 can manage a set of “second” scheme handling procedures 223. For example, the request scheme manager component 214, based on the detection of one or more scheme modifiers by the URI parser component 220, can determine a template or a set of partial templates stored in a template database 226 and accessible via a template interface 224, where each template or template set is associated with at least one detected scheme modifier. A default template may be provided for the case when no scheme modifiers are detected and processing is completed by the first scheme handling procedure. Other templates or template sets are associated with a second scheme handler procedure 223. The request scheme manager component 214 passes a template, template set, or an identifier for a template or template set to the operation controller component 222. The request scheme manager component 214, in one aspect, can provide a plug-in interface to allow support for new second scheme handlers 224 to be added using plug-in procedures. Scheme handling procedures 223 may include scheme handling procedures not associated with a template for processing not associated with the building of a request. For example, a scheme modifier indicating that a secure protocol, such as SSL, may be associated with a second scheme handling procedure that when processed uses a secure session to send a request without need of a template.

Accordingly, in one aspect, the scheme manager component 214 can be configured for determining a second scheme handling procedure for processing the URI based on the detected URI scheme modifier by selecting a template based on the scheme modifier, wherein the selected template provides for determining the second scheme handling procedure for processing the URI, or may determine a second scheme handling procedure using a present scheme modifier as an identifier of the second scheme handling procedure. For example, the scheme manager component 214 can be configured for determining a second scheme handling procedure for processing the URI based on the detected URI scheme modifier by selecting a transport protocol to use for transporting a message associated with the URI, as discussed above.

As illustrated in the web server device 302 of FIG. 3, a scheme manager component 312 is configured for determining, based on the detected URI scheme modifier, a second scheme handling procedure 316 for processing the URI. Accordingly, as discussed above, the scheme handling procedure 316 determines a procedure for processing of the message and/or an associated operation by determining a second scheme procedure 316 associated with the scheme modifier, such as the “copy-dest” modifier described above. Similar to the arrangement described above, templates (not shown) can be used but, as above, are not required.

Returning to FIG. 1, in block 108 the determined second scheme handling procedure is used to process the URI for performing an operation based on the URI. Accordingly, a system for determining scheme handling procedures for processing URIs based on URI scheme modifiers includes means for using the determined second scheme handling procedure to process the URI for performing an operation based on the URI. For example, as illustrated in FIG. 2, an operation controller component 222 is configured for using the determined second scheme handling procedure to process the URI for performing an operation based on the URI.

In one aspect, the operation controller component 222 can be configured for using the determined second scheme handling procedure to process the URI for building a message that includes content and/or uses a transport protocol based on the URI scheme modifier. In another aspect, the operation controller component 222 can be configured for using the determined second scheme handling procedure to process the URI for sending a message using a transport protocol based on the URI scheme modifier and/or using a protocol command based on the URI scheme modifier.

For example, in the example illustrated by FIG. 2, an operation controller component 222 receives either the appropriate second scheme handling procedure 223 or information identifying the second scheme handling procedure 223 that is determined by the scheme manager component 214. In the example, as discussed above, the second scheme handling procedure 223 may correspond to a template that is accessed in the templates database 226 via the template interface 224. The template typically contains data associated with a given scheme modifier and may include a variable that may be filled in by a scheme modifier value. In determining a template to use, the scheme manager component 214 can pass portions of the parsed URI to the operation controller component 222 along with template identifying information. The portions of the parsed URI are passed to template interface 224 for use in processing the URI portions by using them to complete the associated template. In the case of HTTP requests, a selected template can include a set of standard HTTP headers provided by default for all HTTP requests issued from the browser 202. In one aspect, the scheme manager component 214 can be configured for selecting a template based on the scheme modifier by selecting a template for modifying a header of an HTTP request based on the scheme modifier.

For example, Example 4 below depicts an exemplary template for a standard HTTP GET request with a set of default HTTP headers. Such a template may be used as the default template when no scheme modifier is detected and, thus, is processed without the use of a second scheme handling procedure.

### EXAMPLE 4

GET <URL>HTTP/1.1
Host: finance.myExample.us.com
User-Agent: Mozilla/5.0 (Windows; U; Windows NT 5.1; en-US; rv:1.8.0.7) Gecko/20060909 Firefox/1.5.0.7
Accept:
text/xml,application/xml,application/xhtml+xml,text/html;q=0.9,text/plain;q=0.8,image/png,image/jpeg
Accept-Language: en-us,en;q=0.5
Accept-Encoding: gzip,deflate
Accept-Charset: ISO-8859-1,utf-8;q=0.7,*;q=0.7
Keep-Alive: 300
Connection: keep-alive

As discussed above, the templates database 226 stores templates for use when certain scheme modifiers are detected. The templates can include, for example, request templates, header templates for specific headers, content templates for support of various content types, and templates for other portions that may be required by some HTTP requests. The variety of templates corresponds to the variety of second scheme handling procedures 223 available for use by the operation controller component 222, as identified by the scheme manager component 214 based on scheme modifiers detected by the URI parser component 220. Partial templates allow the operation controller component 222 to use multiple second scheme handling procedures 223 to construct a request from HTTP request parts.

In the current example, the scheme modifier, “content-type=+image/*”, indicates the HTTP Accept header must indicate the browser 202 will accept all image types in addition to any default MIME types accepted by the browser 202 by default. The “+” indicates according to a particular scheme modifier format that the value is a content type that must be accepted. A “−” indicates a content-type that must not be accepted. A value possibly including multiple MIME type identifiers without a preceding “+” or “−” indicates the value must be used as the complete Accept header value. Other formats are also possible, some of which are discussed in this document.

When a scheme modifier is detected by the URI parser component 220 and identified to the scheme manager component 214, the scheme manager component 214 can determine, for example, a template or set of templates to be used in building a particular request. The scheme manager component 214 indicates for the scheme modifier, “content-type=+image/*”, that a standard request header may be used as an HTTP Accept header template. The scheme manager component 214 determines that no template is associated with the scheme modifier, transport=ssl, but an associated identifier is passed to the operation controller component 222 causing it to use an associated second scheme handler for establishing an SSL session for sending the HTTP request being built.

The scheme manager component 214 selects a standard template such as the template in Example 4 and, for example, a cookie template, Cookie: <cookies>, when a cookie scheme modifier is detected by the URI parser component 220. The templates or corresponding identifiers are provided to the operation controller component 222. The operation controller component 222 invokes the template interface 224 for providing the cookie template and a value from the detected cookie scheme modifier. The template interface 224 returns a cookie header with the cookie value of the cookie scheme modifier. The operation controller component 222 invokes a second scheme handling procedure 223 for providing the default template and the completed cookie template as input by merging the two templates, and for filling in the <URL>variable in the template. The operation controller component 222, based on an identifier associated with the scheme modifier, “content-type=+image/*”, invokes the template interface 224, which appends “image/*” to the HTTP Accept header in the HTTP request built thus far.

Typically, a URI with the scheme HTTP is sent over a network using an unsecured network transport protocol, for example TCP. In the current example, the scheme modifier, “transport=ssl”, indicates that the scheme manager component 214 must send the request using the secure sockets layer protocol (SSL) 230. Conventionally, to use SSL, a different scheme, HTTPS, is specified, although the application protocol, HTTP, is unaffected. This demonstrates that, in order to support a secure protocol other than SSL, the conventional URI format currently in use would require the creation of an additional scheme. Scheme modifiers provide greater flexibility. The HTTP protocol is not tied to any specific transport protocol, thus binding a scheme name indicating an application protocol to a particular transport protocol is an unnecessary tying of distinct system elements. With scheme modifiers, a default transport is selectable by an application, such as browser 202. The default transport is typically TCP. A scheme modifier such as the exemplary transport scheme modifier allows a user, programmer, service, and/or application to specify the transport network to be used independent of the application protocol associated with the scheme, HTTP in this example. Thus a modifier such as, “transport=UDP”, indicates HTTP should be transported using UDP datagrams. In the example, SSL is the specified transport. The transport scheme modifier or equivalents allow for new security protocols to be specified and used without altering the scheme itself which is HTTP, in the example.

In the current example, the operation controller component 222, based on input from the scheme manager component 214 associated with the scheme modifier, “transport=ssl”, invokes a second scheme handling procedure 223 for using the protocol layer 228 for creating an SSL session using an SSL layer 230 protocol component. The sending of the HTTP GET message is altered from the default by the specification of a non-default transport protocol. The HTTP request built using the URI described is passed to the protocol layer 228, such as an HTTP layer, which can accept the request, perform validation, and send it to the identified host, such as the web server device 302, using the SSL layer 230 protocol component operating over a TCP connection created by a TCP layer (not shown) of a network interface 232 in cooperation with network 218 as requested by the protocol layer 228.

For example, the HTTP GET request as shown in Example 4 with the MIME type, “image/*”, added to the list of accepted MIME types, forms an HTTP GET request message which is passed to the SSL Layer 230 along with a session ID of an SSL session created at the request of the request scheme manager component 214, where the SSL generates an encrypted message. The encrypted message and SSL session identifier can be passed via a buffer to the network interface 232, which sends the encrypted message as one or more messages at the TCP layer over a TCP connection created at the request of the SSL layer 230.

In another aspect, the operation controller component 222 is configured for using the determined second scheme handling procedure to process the URI for performing an operation associated with one of a content type, a content format, security, a timeout, an alternate host, error handling, logging, retry, quality of service, routing, a session parameter, correlator, a header, and an access system.

The browser 202 and the request manager component 212 are exemplary components. Other applications that process URIs can similarly carry out the techniques described above. Such applications can include (a nonexclusive list) word processors, data bases (e.g., use “isbn:” scheme to identify and lookup records), data base connections between clients and servers, ftp clients and servers (e.g., “ftp:” scheme), real syndication service (RSS) clients and servers (e.g., “http:” scheme), session initiation protocol (SIP) clients and servers (e.g., “sip:” scheme), instant messaging (IM) clients and servers (e.g., “xmpp:” scheme for jabber, “aim:” scheme for AOL, “msnim:” scheme for MS instant messenger), presence clients and servers (e.g., “sip:”, “xmpp:”, “http:”, “pres:” schemes), news clients and servers (e.g., “news:” scheme), usenet (e.g., “nntp:” scheme), mail (e.g., “imap:”, “pop:”, “smtp:”, “mailto:” schemes), lightweight directory access protocol (LDAP) directories (e.g., “Idap:”), phone-related (e.g., “tel:”, “skype:” for Skype, “fax:”, “telnet:”), file systems (e.g., “nfs:”, “smb:”, “file:” schemes), Gopher protocol (“gopher:”), wide area information server (Wais) (“wais:”), simple network management protocol (SNMP) (e.g., “snmp:”), multimedia messaging service (MMS) (e.g., “mms:”), short messaging service (SMS) (e.g., “sms:”), and many others.

Client device 200 can include a response parser 254 for detecting a URI scheme modifier in a URI received in connection with a response to the request, by, for example, parsing the received response. Exemplary response scheme modifiers are discussed above. Client device 200 can also include a response scheme manager component 252 for determining, based on a URI scheme modifier, a second scheme handling procedure for processing the URI, and for using the determined second scheme handling procedure to process the URI for performing an operation based on the URI, as discussed above with respect to requests. For example, a “log=http://mylogserver/logs/appA.log”, scheme modifier may be used as a request sender, request receiver, response sender, and/or a response receiver scheme modifier that causes a second scheme handling procedure to be used for each allowing a client and a server to share a common log. This is not possible with current URIs and can only be done with custom code for each application that uses URIs. The scheme modifier provides a standard mechanism for enabling logging without modification to any applications that use scheme managers for processing requests and responses based on a URI. As just illustrated, the response scheme manager component 252 can also be configured to generate a response message with a scheme modifier, similar to generating a request message as described herein.

As illustrated in FIG. 3, an operation controller component 222 is configured for using the determined second scheme handling procedure to process the URI for performing an operation based on the URI.

In one aspect, the operation controller component 222 can be configured for using the determined second scheme handling procedure to process the URI for processing the received message and for performing the operation using the determined second scheme handling procedure responsive to the message. In another aspect, the operation controller component 222 is configured for performing the operation using the determined second scheme handling procedure responsive to the message by building a response to the message. One skilled in the art will appreciate that scheme modifiers can be provided that determine alternate procedures that are different from the normal procedures for processing of operations of both a sender and a receiver of a message based on detecting a scheme modifier in the URI by both the sender and the receiver. For example, in some cases, a message can be received, such as a request, that includes a scheme modifier. A response to the request can be generated that contains a modified scheme modifier portion of the URI received in the request by providing the URI to a response scheme manager component 336 for building and sending the response using a scheme handling procedure associated with the received scheme modifier and by introducing a scheme modifier in the response for processing by the sender of the request. Examples have been provided above. Both modifiers in the request and in the response can serve to determine procedures for processing the received request and the received response, respectively.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for determining scheme handling procedures for processing URIs based on URI scheme modifiers, the method comprising:
receiving a URI having a URI scheme name, a URI scheme modifier, and a scheme hierarchical part, wherein the URI scheme name identifies a first scheme handling procedure for processing the URI;
detecting the URI scheme modifier in the received URI;
determining, based on the detected URI scheme modifier, a second scheme handling procedure for processing the URI; and
using the determined second scheme handling procedure to process the URI for performing an operation based on the URI.

2. The method of claim 1 wherein receiving a URI includes receiving a URI at a client device via an input subsystem of the client device.

3. The method of claim 1 wherein receiving a URI includes receiving a URI in a message.

4. The method of claim 3 wherein receiving a URI in a message includes receiving a URI in an HTTP request.

5. The method of claim 1 wherein detecting the URI scheme modifier in the received URI includes parsing the URI.

6. The method of claim 1 wherein determining a second scheme handling procedure for processing the URI based on the detected URI scheme modifier includes selecting a template based on the scheme modifier, wherein the selected template provides for determining the second scheme handling procedure for processing the URI.

7. The method of claim 6 wherein selecting a template based on the scheme modifier includes selecting a template for modifying a header of an HTTP request based on the scheme modifier.

8. The method of claim 1 wherein determining a second scheme handling procedure for processing the URI based on the detected URI scheme modifier includes selecting a transport protocol to use for transporting a message associated with the URI, wherein the transport protocol is selected based on the detected URI scheme modifier.

9. The method of claim 1 wherein using the determined second scheme handling procedure to process the URI for performing an operation includes building a message that one of includes content and uses a transport protocol based on the URI scheme modifier.

10. The method of claim 1 wherein using the determined second scheme handling procedure to process the URI for performing an operation includes sending a message using a transport protocol based on the URI scheme modifier.

11. The method of claim 3 wherein using the determined second scheme handling procedure to process the URI for performing an operation includes processing the received message and performing the operation using the determined second scheme handling procedure responsive to the message.

12. The method of claim 11 wherein performing the operation using the determined second scheme handling procedure responsive to the message includes building a response to the message.

13. The method of claim 1 wherein the URI scheme modifier is specified in the URI using one of a positional format, a keyword-value format, and a command format.

14. The method of claim 1 wherein using the determined second scheme handling procedure to process the URI for performing an operation includes using the second scheme handling procedure to process the URI for performing an operation associated with one of a content type, a content format, security, a timeout, error handling, logging, retry, quality of service, routing, a session parameter, correlator, a header, and an access method.

15. system for determining scheme handling procedures for processing URIs based on URI scheme modifiers, the system comprising:
means for receiving a URI having a URI scheme name, a URI scheme modifier, and a scheme hierarchical part, wherein the URI scheme name identifies a first scheme handling procedure for processing the URI;
means for detecting the URI scheme modifier in the received URI;
means for determining, based on the detected URI scheme modifier, a second scheme handling procedure for processing the URI; and
means for using the determined second scheme handling procedure to process the URI for performing an operation based on the URI.

16. A system for determining scheme handling procedures for processing URIs based on URI scheme modifiers, the system comprising:
a request manager component configured for receiving a URI having a URI scheme name, a URI scheme modifier, and a scheme hierarchical part, wherein the URI scheme name identifies a first scheme handling procedure for processing the URI;
a URI parser component configured for detecting the URI scheme modifier in the received URI;
a scheme manager component configured for determining, based on the detected URI scheme modifier, a second scheme handling procedure for processing the URI; and
an operation controller component configured for using the determined second scheme handling procedure to process the URI for performing an operation based on the URI.

17. The system of claim 16 wherein the request manager component is configured for receiving a URI at a client device via an input subsystem of the client device.

18. The system of claim 16 wherein the request manager component is configured for receiving a URI in a message.

19. The system of claim 18 wherein the request manager component is configured for receiving a URI in an HTTP request.

20. The system of claim 16 wherein the URI parser component is configured for parsing the received URI for detecting a scheme modifier in the received URI.

21. The system of claim 16 wherein the scheme manager component is configured for determining a second scheme handling procedure for processing the URI based on the detected URI scheme modifier by selecting a template based on the scheme modifier, wherein the selected template provides for determining the second scheme handling procedure for processing the URI.

22. The system of claim 21 wherein the scheme manager component is configured for selecting a template based on the scheme modifier by selecting a template for modifying a header of an HTTP request based on the scheme modifier.

23. The system of claim 16 wherein the scheme manager component is configured for determining a second scheme handling procedure for processing the URI based on the detected URI scheme modifier by selecting a transport protocol to use for transporting a message associated with the URI, wherein the transport protocol is selected based on the detected URI scheme modifier.

24. The system of claim 16 wherein the operation controller component is configured for using the determined second scheme handling procedure to process the URI for building a message that one of includes content and uses a transport protocol based on the URI scheme modifier.

25. The system of claim 16 wherein the operation controller component is configured for using the determined second scheme handling procedure to process the URI for sending a message using a transport protocol based on the URI scheme modifier.

26. The system of claim 18 wherein the operation controller component is configured for using the determined second scheme handling procedure to process the URI for processing the received message and for performing the operation using the determined second scheme handling procedure responsive to the message.

27. The system of claim 26 wherein the operation controller component is configured for performing the operation using the determined second scheme handling procedure responsive to the message by building a response to the message.

28. The system of claim 16 wherein the URI scheme modifier is specified in the URI using one of a positional format, a keyword-value format, and a command format.

29. The system of claim 16 wherein the operation controller component is configured for using the determined second scheme handling procedure to process the URI for performing an operation associated with one of a content type, a content format, security, a timeout, error handling, logging, retry, quality of service, routing, a session parameter, correlator, a header, and an access system.

30. A computer readable medium including a computer program, executable by a machine, for determining scheme handling procedures for processing URIs based on URI scheme modifiers, the computer program comprising executable instructions for:
receiving a URI having a URI scheme name, a URI scheme modifier, and a scheme hierarchical part, wherein the URI scheme name identifies a first scheme handling procedure for processing the URI;
detecting the URI scheme modifier in the received URI;
determining, based on the detected URI scheme modifier, a second scheme handling procedure for processing the URI; and
using the determined second scheme handling procedure to process the URI for performing an operation based on the URI.
